(19) United States
(12) Patent Application Publication
(10) Pub. No.: US 2012/0112894 A1
(43) Pub. Date: May 10, 2012

(54) HAPTIC FEEDBACK GENERATOR, PORTABLE DEVICE, HAPTIC FEEDBACK PROVIDING METHOD USING THE SAME AND RECORDING MEDIUM THEREOF

(75) Inventors: Tae-Heon Yang, Daejeon (KR); Dong-Soo Kwon, Daejeon (KR); Sang-Youn Kim, Seoul (KR); Jeong-Hoi Koo, Chungcheongnam-do (KR); Hyo-Geun Ahn, Gyeonggi-do (KR)

(73) Assignee: Korea Advanced Institute of Science and Technology, Daejeon (KR)

(21) Appl. No.: 13/024,108

(22) Filed: Feb. 9, 2011

(30) Foreign Application Priority Data
Nov. 8, 2010 (KR) 10-2010-110406
Nov. 15, 2010 (KR) 10-2010-113497

(51) Int. Cl. H04B 3/36

(52) U.S. Cl. 340/407.1

(57) ABSTRACT

An apparatus and a method for generating haptic feedback and a portable device having the apparatus are provided. The haptic feedback generator changes the property of a magneto-rheological fluid or an electro-rheological fluid using a magnetic field or an electric field and transmits haptic feedback using the property variation. The haptic feedback generator includes a controller 620 outputting a control signal for providing a haptic feedback based on application information selected by a user and a haptic feedback generating unit 610 generating the haptic feedback based on the control signal and providing the haptic feedback in response to an external force Fᵢₙ of the user.

### BACKGROUND OF THE INVENTION

1. Field of the Invention

The present invention relates to a haptic feedback generator and a portable device including the same, and more particularly, to a haptic feedback generator and a portable device for changing the property of a magneto-rheological fluid or an electro-rheological fluid using a magnetic field or an electric field and transmitting a haptic feedback using the property change.

2. Background of the Related Art

Generally, haptic sense is the sense of touch that can be felt with a human finger or a stylus pen when touching an object with the human finger or stylus pen and includes a haptic feedback felt when the human skin touches the surface of the object and a kinesthetic feedback felt when motions of joints and muscles are obstructed.

The human sensory receptor includes Pacinian corpuscle that senses high-frequency vibrations, Meissner's corpuscle that senses low-frequency vibrations, Merkel's disc that senses a locally applied pressure and Ruffini's ending that senses stretch pressing skin as mechanoreceptors.

A variety of haptic representation devices for stimulating the sensory receptor include a piezo actuator, a solenoid actuator, a DC/AC motor, a servo motor, an ultrasonic actuator, a shape-memory alloy ceramic actuator, electroactive polymer actuator, etc. A typical haptic representation device is a device that generates vibrations with a vibration motor in response to an input applied to a touch screen of a mobile device to stimulate Pacinian/Meissner's corpuscle that senses high-frequency/low-frequency vibrations. The vibration motor is applied to a portable device to transmit a predetermined sense. A conventional vibration motor outputs only vibrations in response to a user's touch of a touch panel.

Conventional haptic representation devices stimulate only cutaneous sense, which is different from touching an actual object, and thus the sense of reality is reduced. People rub an object while pressing the object using hand/arm joints. Here, the people feel the stiffness of the object and recognize the roughness of the object depending on a degree to which the object is pressed.

Although it is important for the sensory reception that people feel the stiffness of an object using kinaesthesia, the conventional haptic representation devices simply output only vibrations, and thus there is a limitation in satisfying various sensual desires of users.

Accordingly, it is required to develop a haptic feedback generator applied to portable devices, which actually stimulates the human kinaesthesia to make people feel various levels of object's stiffness.

### SUMMARY OF THE INVENTION

Accordingly, the present invention has been made in view of the above-mentioned problems occurring in the prior art, and it is a primary object of the present invention to provide various kinesthetic feedbacks to a user by continuously varying resistance or changing resistance in stages.

To accomplish the above object of the present invention, according to the present invention, there is provided a haptic feedback generator comprising a controller 620 outputting a control signal for providing a haptic feedback based on application information selected by a user; and a haptic feedback generating unit 610 generating the haptic feedback based on the control signal and providing the haptic feedback in response to an external force Fᵢₙ of the user.

To accomplish the above object of the present invention, according to the present invention, there is also provided a portable device comprising a controller 620 outputting a control signal for providing a haptic feedback based on application information selected by a user; and a haptic feedback generator 600 having a haptic feedback generating unit generating the haptic feedback based on the control signal and providing the haptic feedback in response to an external force Fᵢₙ of the user.

To accomplish the above object of the present invention, there is also provided a haptic feedback providing method comprising a step S110 in which a controller 620 receives application information executed in a portable device in order to generate a haptic feedback corresponding to the application information; a step S120 in which the controller 620 determining a haptic feedback method based on the application information; and a step S140 in which the controller 620 transmits the haptic feedback to a user based on the determined haptic feedback method.

To accomplish the above object of the present invention, there is also provided a computer readable recording medium storing a program for executing the haptic feedback providing method.

To accomplish the above object of the present invention, there is also provided a haptic feedback generator comprising a magnetic field generator 110 generating a magnetic field 1 for changing the property of a magneto-rheological fluid 20 to transmit a haptic feedback to a user and providing a closed magnetic route through which the magnetic field 1 can flow; and a force transmitter 120 combined with the magnetic field generator 110 such that the magnetic field 1 flows through the force transmitter, wherein the magnetic field 1 is formed at the combined portion of the magnetic field generator 110 and the force transmitter 120 in a direction different from the moving direction of the force transmitter 120 and changes the property of the magneto-rheological fluid 20 located on the route of the magnetic field 1.

To accomplish the above object of the present invention, there is also provided a haptic feedback generator comprising an electric field generator 210 generating an electric field 2 for changing the property of an electro-rheological fluid 30 to transmit a haptic feedback to a user; and a force transmitter 220 through which the electric field 2 generated by the electric field generator 210, the force transmitter 120 cutting a chain of the electro-rheological fluid 30, which is formed according to the electric field 2, to generate the haptic feedback, wherein the electric field 2 is formed in a direction different from the moving direction of the force transmitter 220 and changes the property of the electro-rheological fluid 30.

To accomplish the above object of the present invention, there is also provided a haptic feedback generator comprising a magnetic field generator 310 having a solenoid coil 311 generating a magnetic field 1 for changing the property of a magneto-rheological fluid 20 to transmit a haptic feedback to a user, a solenoid outer core 317 coming into contact with both sides of the solenoid coil 311 and providing a closed magnetic route through which the magnetic field 1 can flow along the solenoid outer core 317, and a solenoid inner core 313 arranged in a direction corresponding to the solenoid coil 311 on the route through which the magnetic field 1 flows; and a force transmitter 320 combined with the solenoid inner core 313 and the solenoid outer core 317, the magnetic field 1 flowing through the force transmitter 320, wherein the magnetic field 1 is formed in a direction different from the moving direction of the force transmitter 320 at the combined portion of the solenoid inner core 313, the solenoid outer core 317 and the force transmitter 320 and changes the property of the magneto-rheological fluid 20 located on the route of the magnetic field 1.

To accomplish the above object of the present invention, there is also provided a portable device comprising a haptic feedback generator 40 according to claim 19; and a microprocessor 45 transmitting/receiving signals to/from the haptic feedback generator 40.

To accomplish the above object of the present invention, there is also provided a portable device comprising a haptic feedback generator 50 according to claim 27; and a microprocessor 55 transmitting/receiving signals to/from the haptic feedback generator 50.

To accomplish the above object of the present invention, there is also provided a portable device comprising a haptic feedback generator 60 according to claim 34; and a microprocessor 65 transmitting/receiving signals to/from the haptic feedback generator 60.

As described above, the present invention can vary resistance in stages to provide various kinesthetic feedbacks to a user. Furthermore, the present invention can continuously change resistance to provide various kinesthetic feedbacks to the user. In addition, the present invention can allow the user to know the state of a portable device or set the state of the portable device even without seeing the portable device.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 illustrates a configuration of a haptic feedback generator according to a first embodiment of the present invention;

FIG. 2 illustrates the configuration of the haptic feedback generator according to the first embodiment of the present invention in detail;

FIG. 3 illustrates the configuration of the haptic feedback generator according to the first embodiment of the present invention in detail;

FIG. 4 is a graph showing resistances generated in stages according to the first embodiment of the present invention;

FIG. 5 is a graph showing resistances generated in stages according to the first embodiment of the present invention;

FIGS. 6 through 14 are graphs showing resistance continuously generated according to the first embodiment of the present invention;

FIG. 15 is a block diagram of a portable device according to a second embodiment of the present invention;

FIG. 16 is a perspective view of the portable device according to the second embodiment of the present invention, which is combined with a haptic feedback generator;

FIG. 17 is a flowchart showing a haptic feedback providing method according to the first embodiment of the present invention;

FIG. 18 is a perspective view of a haptic feedback generator according to a third embodiment of the present invention;

FIG. 19 is an exploded perspective view of the haptic feedback generator according to the third embodiment of the present invention;

FIG. 20 is a front view showing magnetic field flow in the haptic feedback generator according to the third embodiment of the present invention;

FIG. 21 is a perspective view of a haptic feedback generator according to a fourth embodiment of the present invention;

FIG. 22 is an exploded perspective view of the haptic feedback generator according to the fourth embodiment of the present invention;

FIG. 23 is an enlarged perspective view of an electrode plate of the haptic feedback generator according to the fourth embodiment of the present invention;

FIG. 24 is a front view showing magnetic field flow in the haptic feedback generator according to the fourth embodiment of the present invention;

FIG. 25 is a perspective view of a haptic feedback generator according to a fifth embodiment of the present invention;

FIG. 26 is an exploded perspective view of the haptic feedback generator according to the fifth embodiment of the present invention;

FIG. 27 is a front view showing magnetic field flow in the haptic feedback generator according to the fifth embodiment of the present invention; and

FIGS. 28, 29 and 30 are perspective views of portable devices respectively including the haptic feedback generator according to the third, fourth and fifth embodiments of the present invention.

### DETAILED DESCRIPTION OF THE PREFERRED EMBODIMENT

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

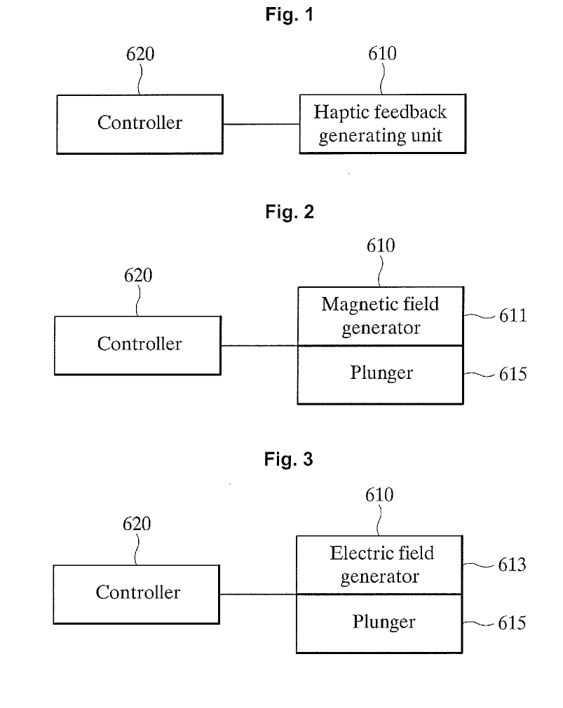

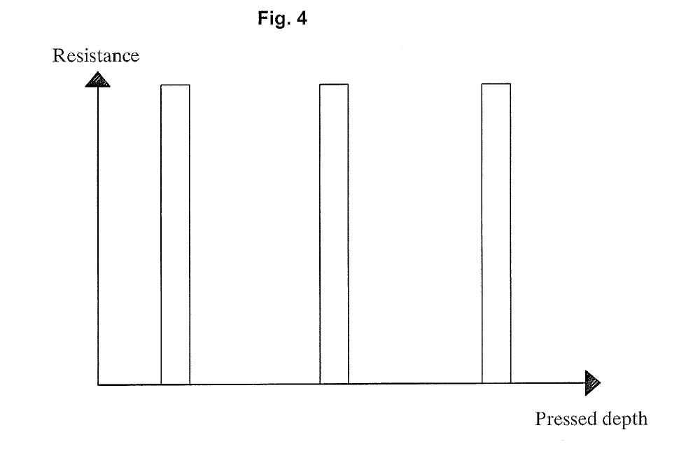

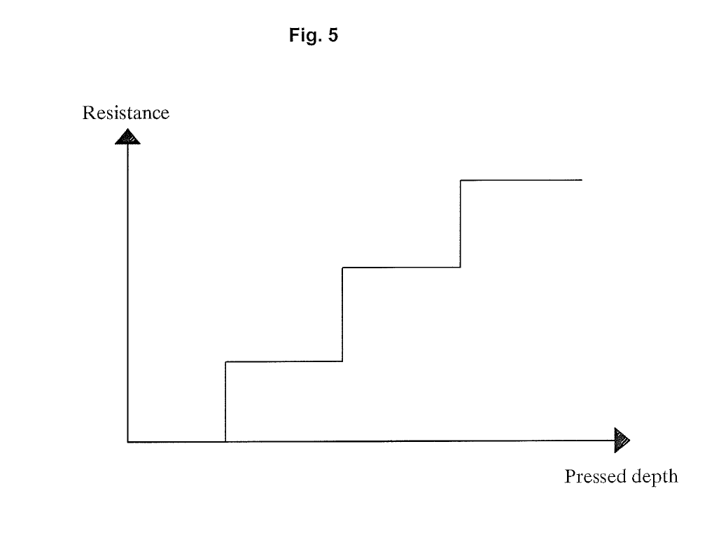

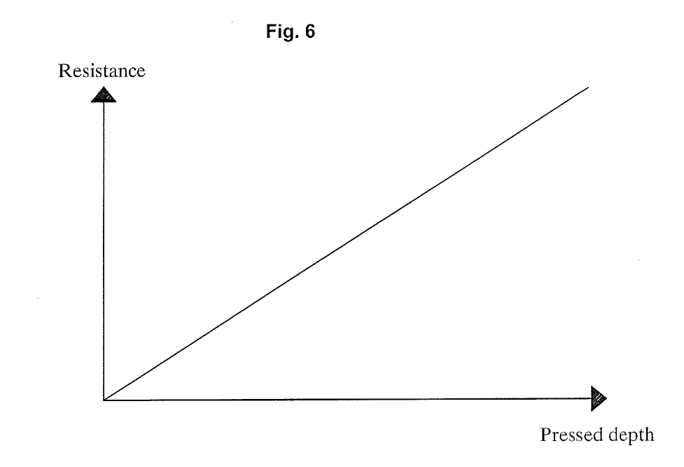

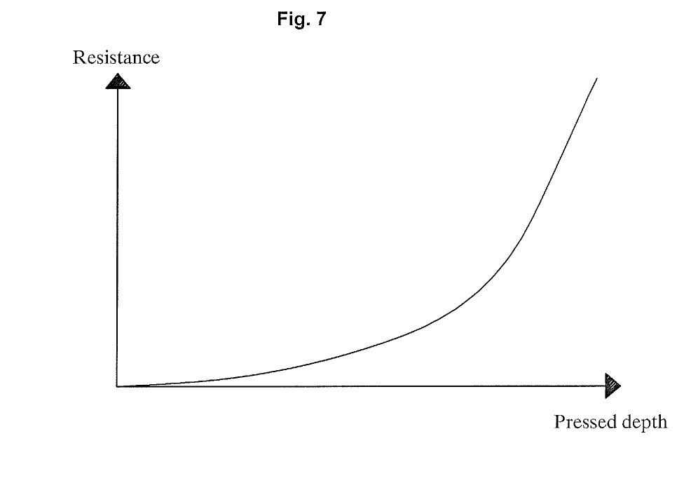

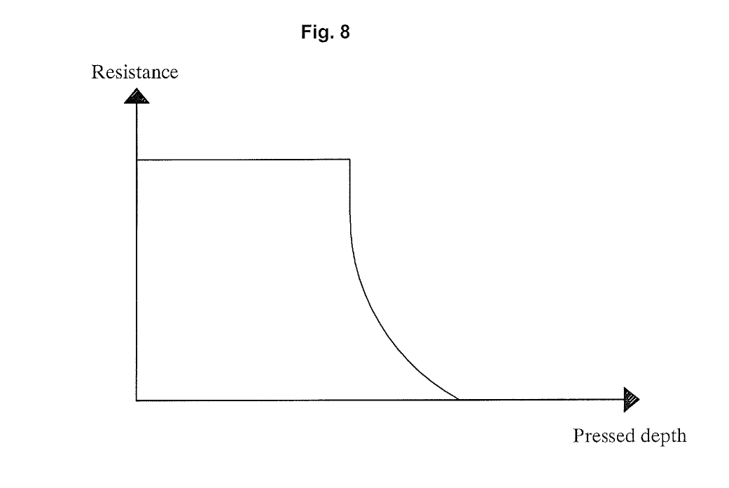

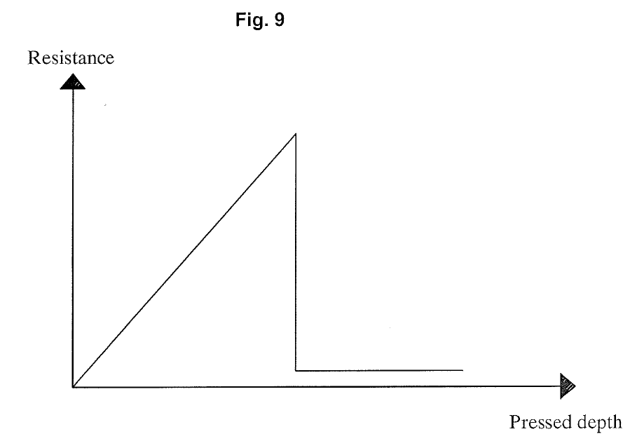

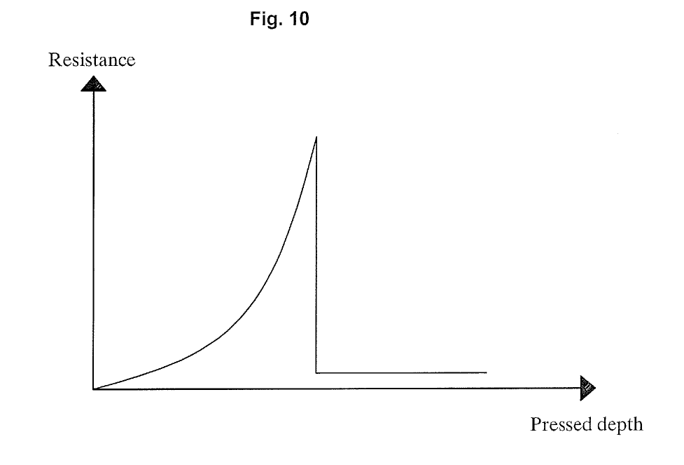

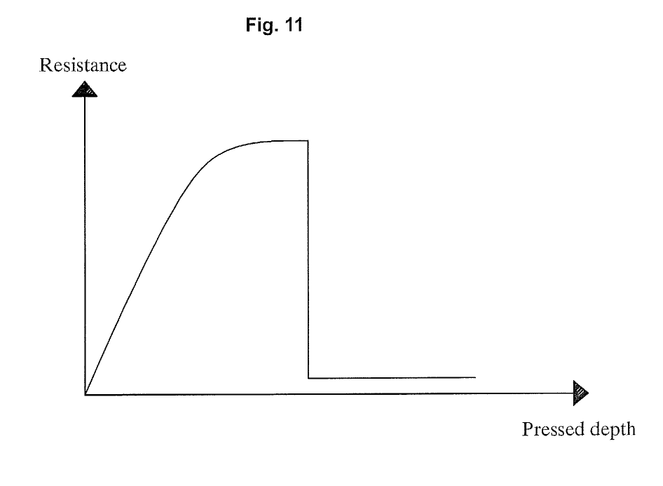

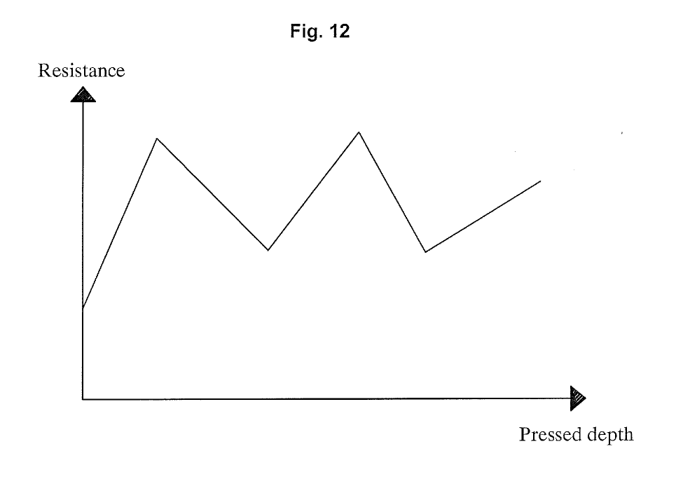

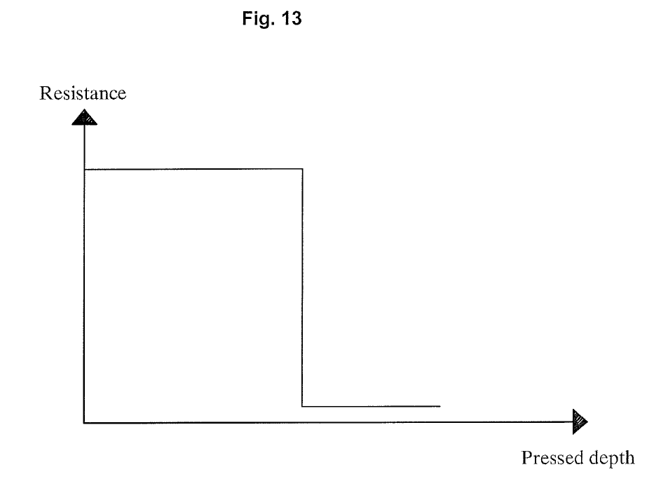

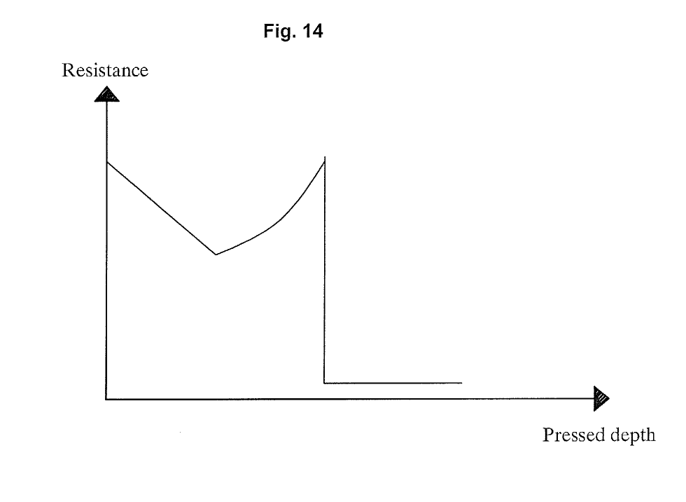

FIG. 1 illustrates a configuration of a haptic feedback generator according to a first embodiment of the present invention and FIGS. 2 and 3 illustrate the configuration of the haptic feedback generator according to the first embodiment of the present invention in detail. FIGS. 4 and 5 are graphs showing resistances generated in stages according to the first embodiment of the present invention and FIGS. 6 through 14 are graphs showing resistance continuously generated according to the first embodiment of the present invention.

Referring to FIGS. 1, 2 and 3, the haptic feedback generator according to the first embodiment of the present invention may include a haptic feedback generating unit 610 and a controller 620. The haptic feedback generating unit 610 may include a magnetic field generator 611 or an electric field generator 613 and a plunger 615. The configuration of the haptic feedback generator according to the first embodiment of the present invention will now be explained in detail with reference to FIGS. 1 through 14.

The haptic feedback generating unit 610 according to the first embodiment of the present invention generates a haptic feedback based on a control signal of the controller 620, which will be described later, and provides the haptic feedback in response to an external force of a user. The haptic sense may be kinaesthesia or sense of touch. The haptic feedback is providing resistance to the user. The resistance may be a variation in shearing force or stiffness.

The haptic feedback generating unit 610 is composed of the magnetic field generator 611 or the electric field generator 613 and the plunger 613, as shown in FIGS. 2 and 3. The haptic feedback generating unit 610 using the magnetic field generator 611 generates resistance by using a magneto-rheological fluid and a magnetic field. Specifically, the magnetic field generator 611 generates a magnetic field having intensity depending on a control signal of the controller 620 and applies the generated magnetic field to the magneto-rheological fluid. The magnetic field changes the resistance of the magnetic rheological fluid, that is, shearing force or stiffness. Accordingly, the user can receive various haptic feedbacks. Here, a solenoid core (not shown) and a solenoid coil (not shown) may be used to generate the magnetic field.

To change the intensity of the magnetic field requires an analog voltage. Accordingly, a digital-to-analog converter (DAC) (not shown) is controlled using a pulse width modulation (PWM) signal output from a microprocessor (not shown) included in the controller 620. An analog voltage output from the DAC is applied to the haptic feedback generator to change the intensity of the magnetic field.

The haptic feedback generating unit 610 using the electric field generator 613 generates resistance using an electro-rheological fluid and an electric field. Specifically, the electric field generator 613 generates an electric field having intensity depending on a control signal of the controller 620 and applies the generated electric field to the electro-rheological fluid. The applied electric field changes the resistance of the electro-rheological fluid, that is, shearing force or stiffness. Accordingly, the user can receive various haptic feedbacks. Here, electrodes, that is, positive and negative poles are used to generate the electric field.

To change the intensity of the electric field, an analog voltage of several kV is required. The DAC (not shown) is controlled using a PWM signal output from the microprocessor (not shown) in order to obtain the analog voltage. The analog voltage output from the DAC (not shown) is inputted to a DC-DC converter (not shown) and amplified, and then the amplified analog voltage is applied to the haptic feedback generator to change the intensity of the electric field.

While there may be various haptic feedback providing methods, the present invention transmits a haptic feedback to the user using a resistance on/off method, a method of continuously generating resistance, or a method generating resistance in stages, as shown in FIGS. 4 through 8.

Specifically, the resistance on/off method provides resistance or not. This method may be used for status information of a portable device, phone charge information of the portable device or information on operation importance of the portable device. The status information of the portable device may be miss call, antenna receive signal strength, battery capacity or state of an available memory. The phone charge information may be applied when an expensive function (for example, pay information, international call) is used. In addition, the resistance on/off method may be used based on a degree of focus when a picture is taken by a camera included in the portable device or a general camera.

The method of generating resistance in stages provides resistances in stages, as shown in FIGS. 4 and 5. FIG. 4 shows resistance depending on the pressed depth of the haptic feedback generator 600 and FIG. 5 shows that resistance increases in stages according to the pressed depth. This method can be used when the speed of a character, an airplane or a car in a game is controlled and useful when a specific button is controlled without watching the screen of the portable device. Furthermore, this method can be used when the user is informed of the state (for example, locked state) of the portable device.

The method of continuously generating resistance continuously provides resistance, as shown in FIGS. 6 through 14. This method can provide feeling of pressing a specific button in various manners. Particularly, this method may be used when feeling of pressing a button is provided in various manners in response to uphill, downhill and the state of road surface in a racing game, for example.

More specifically, resistance may increase compared with an external force, the resistance may increase and then decrease or this increase and decrease may be repeated. Furthermore, the resistance may be constant and then abruptly decrease or the resistance may be constant and then gradually decrease. Moreover, constant resistance may act initially and then gradually decrease.

The controller 620 according to the first embodiment of the present invention outputs a control signal for providing a haptic feedback based on application selected by the user to the haptic feedback generating unit 610. Here, the application selected by the user may include various application information items. For example, various haptic feedbacks are provided based on applications executed in a cellular phone, i-pad, notebook computer and console game machine.

The controller 620 may be configured in the form of MCU, MPU or DSP and may be implemented using FPGA or ASIC. The controller 620 may be included in the haptic feedback generating unit 610 and, if required, may be separated from the haptic feedback generating unit 610, which is apparent to those skilled in the art.

The haptic feedback generator 600 including the above-described haptic feedback generating unit 610 and the controller 620 may be included in a portable device 700 which requires various haptic feedbacks. The portable device 700 can reduce the number of clicking operations for a specific operation by using the haptic feedback generator 600.

<Haptic Feedback Providing Method According to the First Embodiment>

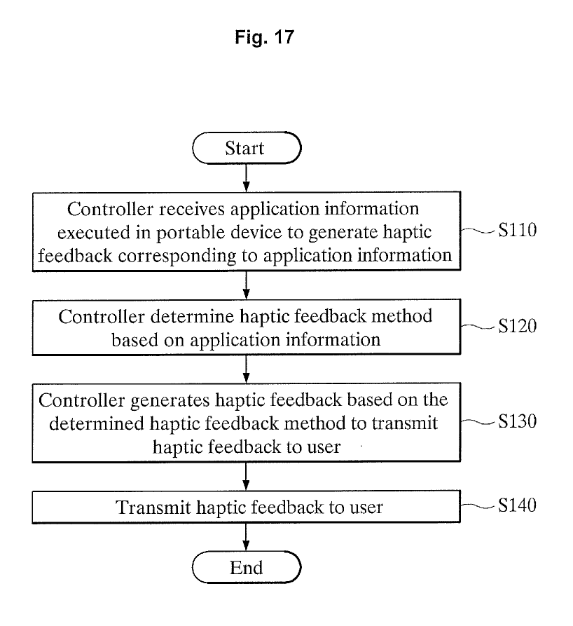

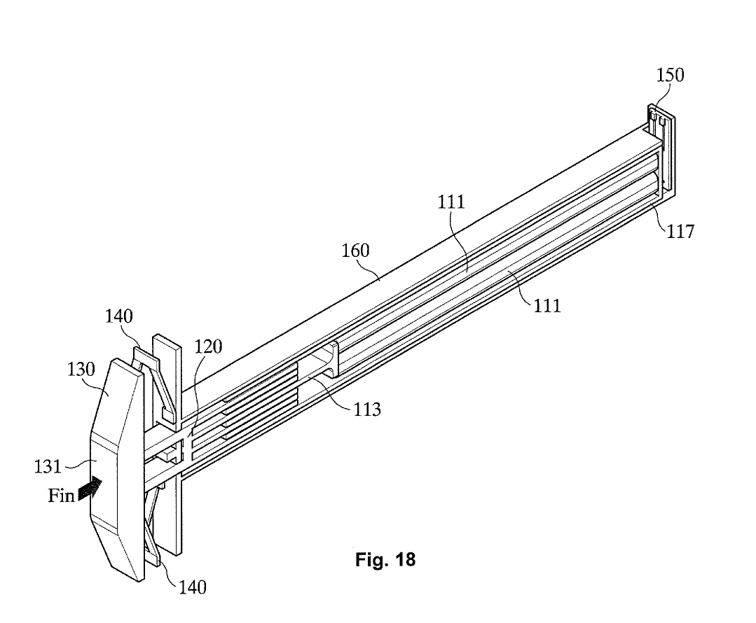

FIG. 17 is a flowchart showing a haptic feedback providing method according to the first embodiment of the present invention. FIG. 17 shows an implementation of the haptic feedback providing method which can be performed by the portable device having the aforementioned configuration.

Referring to FIG. 17, the haptic feedback providing method according to the first embodiment of the present invention includes steps S120, S120, S130 and S140. The steps S110, S120, S130 and S140 will now be explained in detail with reference to FIG. 17.

The controller 620 receives information on an application executed in the portable device in order to generate a haptic feedback corresponding to the application in the step S110. The application information includes various information items as described above. The haptic feedback means shearing force or stiffness corresponding to resistance. Though the application information may be received from a microprocessor (not shown) that executes the application of the portable device 700, the controller 620 may use information thereof when the controller 620 directly executes the application of the portable device 700.

Then, the controller 620 determines a haptic feedback method based on the application information in the step S120. The haptic feedback method may be one of the resistance on/off method, the method of continuously generating resistance and the method of generating resistance in stages. To determine the haptic feedback method, the controller 620 receives the information on the application being executed since the haptic feedback method depends on the application.

Subsequently, the controller 620 generates the haptic feedback in order to transmit the haptic feedback to the user based on the determined haptic feedback method in the step S130. The haptic feedback is generated by generating a magnetic field or an electric field using the haptic feedback generating unit 610 included in the haptic feedback generator 600 to change the property of magneto-rheological fluid or electro-rheological fluid so as to vary resistance.

Finally, the controller 620 transmits the haptic feedback to the user in the step S140. The haptic feedback is transmitted in such a manner that the resistance is changed according to the variation in the property of the magneto-rheological fluid or electro-rheological fluid and the changed resistance is transmitted to the plunger 615. The plunger 615 is a part corresponding to the user's external force and can transmit a resistance variation to the user.

In the aforementioned haptic feedback providing method, although the controller 620 performs all the functions, the microprocessor 720 may execute all or parts of the functions if required.

### Configuration of Second Embodiment

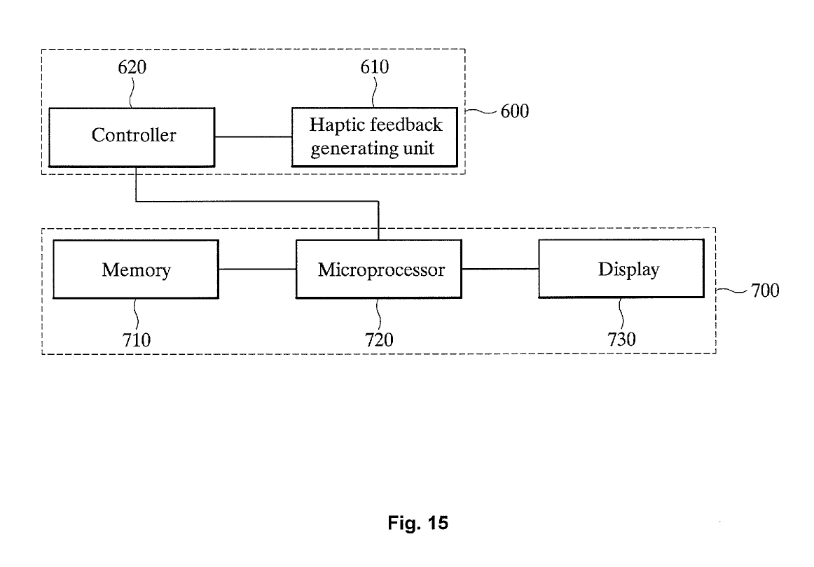

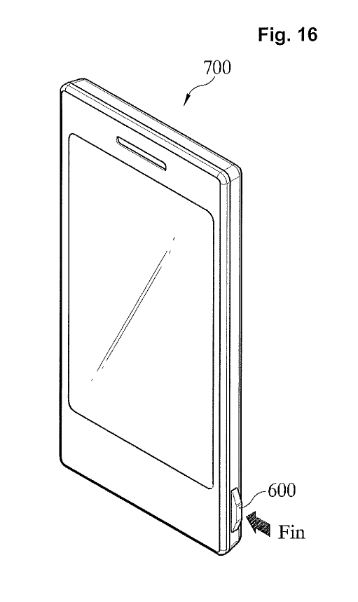

FIG. 15 is a block diagram of a portable device 700 according to a second embodiment of the present invention and FIG. 16 is a perspective view of the portable device 700 according to the second embodiment of the invention, which is combined with the haptic feedback generator 600.

Referring to FIG. 15, the portable device 700 according to the second embodiment of the invention may include the haptic feedback generator 600, a memory 710, a microprocessor 720, and a display 730. The portable device 700 according to the second embodiment of the invention will now be explained in detail with reference to FIG. 15.

The haptic feedback generator 600 including the controller 620 and the haptic feedback generating unit 610 according to the second embodiment of the present invention is identical to that of the first embodiment of the invention so that explanation thereof is omitted. The haptic feedback generator 600 is included in the portable device 700.

The memory 710 according to the second embodiment of the invention stores applications. That is, the memory 710 stores application programs executed in the portable device 700. In addition, the memory 710 may store programs used in the haptic feedback generator 600 if required.

The memory 710 may use EEPFOM, flash memory or an internal memory built in MCU, MPU and DSP. In this case, the memory 710 may be separated from the microprocessor 720 which will be described later or the microprocessor 720 may has the function of the memory 710.

The microprocessor 720 according to the second embodiment of the present invention executes the applications stored in the memory 710 and outputs application information to the controller 620 according to the executed applications. The applications correspond to various programs executed in the portable device 700. The controller 620 can receive application information from the microprocessor 720 since the controller 620 generates various haptic feedbacks according to the executed programs.

However, the controller 620 and the microprocessor 720 are not required to be separately implemented to embody the present invention. One of the controller 620 and the microprocessor 720 may be integrated into the other.

Accordingly, the microprocessor 720 may be implemented using MCU, MPU, DSP or the like. In addition, the microprocessor 720 may be implemented using FPGA or ASIC. The microprocessor 720 may be included in the haptic feedback generating unit 610 and, if required, separated from the haptic feedback generating unit 610 and included in the portable device 700.

The display 730 according to the second embodiment of the present invention displays application execution state. The display 730 may be omitted in the present invention. Although the display 730 is required if the portable device 700 is a smart phone or a tablet PC, for example, a joystick of a console game machine, used for games, may be implemented without having the display 730.

The display 730 having the above function may use an LCD, OLED or LED. However, the display 730 is not limited thereto and can use any means if the means can display application execution state.

Referring to FIG. 16, the portable device 700 including the haptic feedback generator 600 can be used for a smart phone, PDA, notebook computer, i-pad, Galaxy tab, tablet PC, and games and applied to Xbox 360, Playstation, Nintendo DS or PSP to transmit haptic feedbacks to the user. The portion of the portable device 700 to which the haptic feedback generator 600 is provided can be freely varied.

### Configuration of Third Embodiment

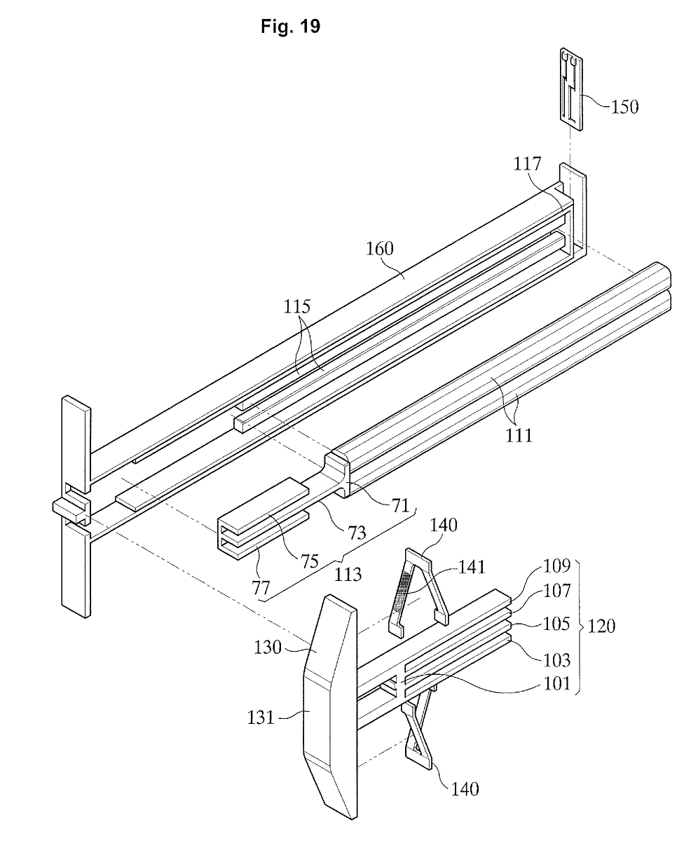

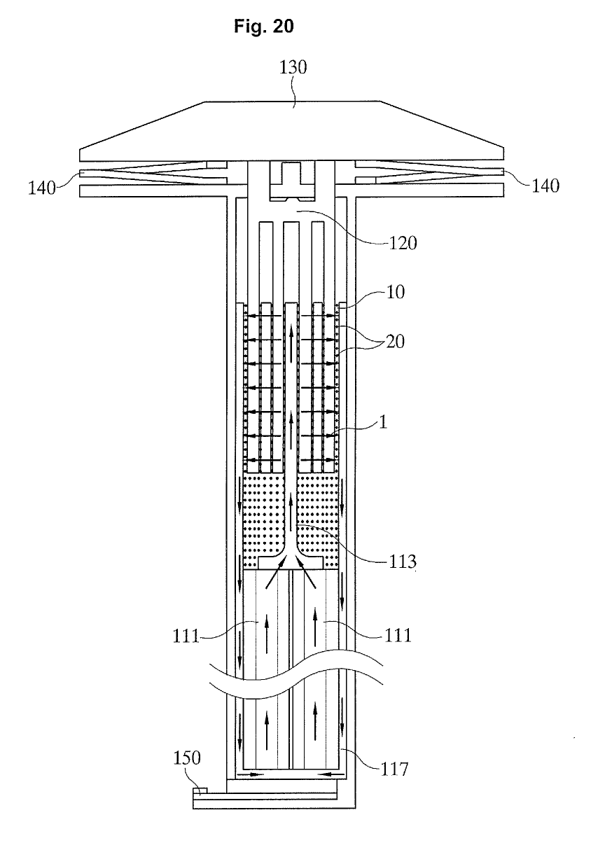

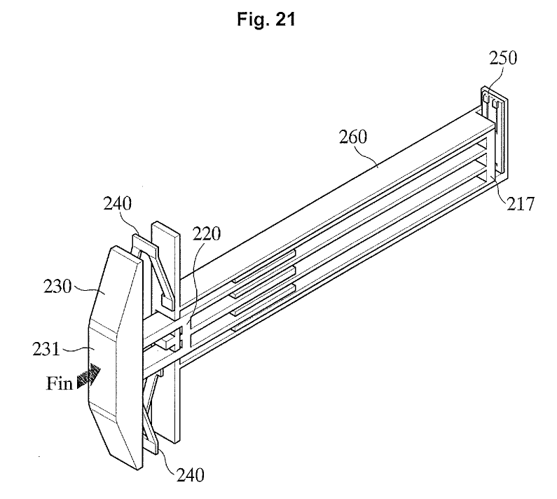

FIG. 18 is a perspective view of a haptic feedback generator according to a third embodiment of the present invention, FIG. 19 is an exploded perspective view of the haptic feedback generator according to the third embodiment of the present invention, and FIG. 20 is a front view showing magnetic field flow in the haptic feedback generator according to the third embodiment of the present invention.

Referring to FIGS. 18, 19 and 20, the haptic feedback generator according to the third embodiment of the present invention may include a magneto-rheological fluid 20, a magnetic field generator, a force transmitter 120 combined with the magnetic field generator, and a push button 130 to which an external force Fᵢₙ of a user is applied. In addition, the haptic feedback generator may include an elastic spring 140 responding to the external force Fᵢₙ of the user, a displacement sensor 141, a housing 160, and a controller 150. The configuration of the haptic feedback generator according to the third embodiment of the present invention will now be explained in detail with reference to FIGS. 18, 19 and 20.

The magneto-rheological fluid 20 is a material having viscosity that reversibly varies according to the intensity of magnetic field and corresponds to one of intelligent materials. Specifically, the magneto-rheological fluid 20 is a non-colloidal suspension composed of a dispersion medium, such as a mineral oil, synthetic hydrocarbon, water, silicon oil or esterified fatty acid, and iron, nickel, cobalt or a magnetic alloy of these materials, which has a diameter of several to tens microns and is dispersed in the dispersion medium.

The magneto-rheological fluid 20 has a large variation in the flowing property such as viscosity according to the intensity of magnetic field and excellent durability. In addition, the magneto-rheological fluid 20 is less sensitive to contaminant, has very high response to a magnetic field and is reversible. Due to these properties, it is evaluated that the magneto-rheological fluid 20 has a high potential to be applied to various industrial fields including the clutch, engine mount and a vibration controller such as a damper of a vehicle, an earthquake-proof device of high-rise buildings, a driver of a robotic system, etc.

Furthermore, the magneto-rheological fluid 20 has the property of Newton fluid when a magnetic field is not applied thereto. When the magnetic field is applied to the magneto-rheological fluid 20, however, dispersed particles form dipoles to construct a fiber structure in a direction parallel with the applied magnetic field. This fiber structure increases viscosity, and thus the magneto-rheological fluid 20 has shearing force obstructing flow of fluid or resistance to flow to considerably increase dynamic yield stress. Here, the yield stress increases with the intensity of magnetic field.

The magneto-rheological fluid 20 is included in an area of the housing 160, in which the magnetic field is formed in the vertical direction. Furthermore, the magneto-rheological fluid 20 is arranged in a sliding tolerance 10 to generate resistance for providing a haptic feedback. Here, haptic sense means kinaesthesia or sense of touch and the haptic feedback is transmitting resistance to the user. The haptic feedback may be to a variation in shear stress or rigidity in the present invention.

The magnetic field generator according to the third embodiment of the present invention generates a magnetic field that causes a variation in the property of the magneto-rheological fluid 20 to transmit a haptic feedback to the user and provides a closed magnetic route through which the magnetic field can flow.

Referring to FIGS. 18 and 19, the magnetic field generator may include solenoid coils 111, a solenoid core 113, iron cores 115, and a solenoid housing 117.

More specifically, each solenoid coil 111 generates a magnetic field according to current flow. The intensity of the magnetic field in the solenoid coil 111 is proportional to the turn number of the coil and the intensity of current. Coils have the same resistance if wires used to wind the coils have the same length, and thus the same current flow through the coils. Accordingly, it is required to increase the turn number of the coil in order to increase the intensity of magnetic field generated according to the coil. The present invention uses a long and thin solenoid coil and includes a plurality of solenoid coils 111 to increase the coil turn number.

Furthermore, each solenoid coil 111 winds around each iron core 115. By doing so, the area in which the magnetic field flows through the air can be minimized to increase the intensity of the magnetic field. The iron cores 115 are arranged at one side of the solenoid housing 117. The number of the iron cores 115 is determined based on the number of the solenoid coils 111.

In addition, positive and negative terminals of the solenoid coils 111 are connected to each other to be provided with current and the solenoid coils 111 are connected to the controller 150, which will be described later, to receive electricity. Moreover, short-circuiting may occur between the solenoid coils 111, and thus an insulating material or package can be provided around the solenoid coils 111 to prevent the short-circuiting of the solenoid coils 111.

The solenoid core 113 comes into contact with one side of each solenoid coil 111 such that the magnetic field generated by the solenoid coil 111 flows through the solenoid core 113. The solenoid core 113 is made of pure iron. In addition, the surface of the solenoid core 113 may be plated with chrome to prevent friction between the solenoid core 113 and the magneto-rheological fluid 20 or other materials.

Referring to FIG. 19, one side of the solenoid core 113 at which the solenoid core 113 is combined with the solenoid coils 111 has a structure for combining multiple magnetic fields into one such that the combined magnetic field flows. The other side of the solenoid core 113 has a structure for shape-fitting combination of the solenoid core 113 and the force transmitter 120 which will be explained later.

More specifically, one side of the solenoid core 113 has a combining part 71 combined with the solenoid coils 111 and the multiple magnetic fields caused by the solenoid coils 111 are combined at the combining part 71. The solenoid core 113 includes a first core 73 extended from the combining part 71 in a direction parallel with the solenoid coils 111 or in the longitudinal direction. Furthermore, the solenoid core 113 includes second and third cores 75 and 77 arranged in parallel having a predetermined distance from the first core 73.

In the solenoid core 113 composed of the first, second and third cores 71, 75 and 77, the magnetic fields generated by the solenoid coils 111 are combined at the combining part 71, the combined magnetic field flows to the first core 73 and the magnetic field flows through the second and third cores 75 and 77 in a direction perpendicular to the moving direction of the force transmitter 120.

The solenoid housing 117 according to the third embodiment of the present invention accommodates the solenoid coils 111 and the solenoid core 113 and provides a route through which the magnetic field formed in the direction perpendicular to the moving direction of the force transmitter 120, which will be described later, flows along the solenoid housing 117. Accordingly, the solenoid housing 117 may have a “□” shape and may be made of pure iron and plated with chrome to reduce friction.

Referring to FIG. 20, the magnetic filed formed in the second and third cores 75 and 77 in the vertical direction flows along the solenoid housing 117 to form a closed magnetic route.

The force transmitter 120 according to the third embodiment of the present invention is shape-fitting-combined with the solenoid core 113 and the solenoid housing 117. In addition, the force transmitter 120 is combined with the push button 130 which will be described later and is moved in one direction when the user's external force Fᵢₙ is applied thereto. The force transmitter 120 may be made of pure iron to allow a magnetic force to easily pass through the force transmitter 120 and plated with chrome to reduce friction.

Referring to FIG. 20, when the force transmitter 120 is moved in one direction according to the user's external force Fᵢₙ, the magneto-rheological fluid 20 enters the sliding tolerance 10. Here, the magneto-rheological fluid 20 included in the sliding tolerance 10 forms a chain according to the magnetic field formed in the direction perpendicular to the moving direction of the force transmitter 120 and generates resistance. This resistance varies with the intensity of the magnetic field. The force transmitter 120 includes first, second, third and fourth force transmitting means 103, 105, 107 and 109 corresponding to the first, second and third cores 73, 75 and 77 to be shape-fitting-combined with the solenoid core 113 and the solenoid housing 117.

Furthermore, the force transmitter 120 includes a combining part 101 that combines the first, second, third and fourth force transmitting means 103, 105, 107 and 109 and is connected with the push button 130. Here, the first, second, third and fourth force transmitting means 103, 105, 107 and 109 may be integrated into one body or respectively formed and combined.

The sliding tolerance 10 is approximately 0.02 to 0.03 mm. Air resistance decreases as the sliding tolerance 10 decreases, and thus the chain can be formed more satisfactorily and the resistance can be maximized.

The push button 130 according to the third embodiment of the present invention is combined with the force transmitter 120. The user's external force Fᵢₙ is applied to the push button 130 to move the force transmitter 120 in a direction perpendicular to the magnetic field.

A sensor 131 for sensing the user's external force Fᵢₙ is provided to the top of the push button 130. The sensor 131 may use a capacitor sensor and makes current flow only when a user's finger touches the sensor 131 so as to allow the magnetic field to be generated. That is, the sensor 131 can sense whether the user's external force Fᵢₙ is applied and output the sensing result to the controller 150.

The elastic spring 140 according to the third embodiment of the present invention is arranged between the housing 160 and the push button 130 and deformed in response to the external force Fᵢₙ applied to the push button 130. Accordingly, the elastic spring 140 may be formed of a material having elasticity. A plurality of elastic springs may be provided if required.

The displacement sensor 141 measures displacement of the force transmitter 120. The displacement sensor 141 includes a piezo film sensor. The piezo film sensor is provided to one side of the elastic spring 140 and generates electromotive force according to bending of the elastic spring 140. When the external force Fᵢₙ is applied, the elastic spring 140 bends and electromotive force corresponding to the bending is generated. Accordingly, the displacement of the elastic spring 140 can be detected based on the electromotive force and the speed can be detected by differentiating the displacement. The resistance to the external force Fᵢₙ is generated using the speed and displacement. The speed and displacement are inputted to the controller 150 which will be described later to drive the haptic feedback generator. A plurality of displacement sensors 141 may be provided if required.

The controller 150 according to the third embodiment of the present invention is provided to one side of the housing 160 which will be described later and transmits/receives a signal to/from an external device. The controller 150 outputs a control signal for varying the intensity of the magnetic field based on the signal. Here, the signal may be the signal of the sensor 131 or the signal of the displacement sensor 141, or a signal corresponding to the speed and displacement.

The controller 150 may include various means for supplying electricity to the solenoid coils 111. These means are apparent to those skilled in the art so that detailed explanation thereof is omitted.

An analog voltage is required to change the intensity of the magnetic field. Accordingly, the DAC (not shown) is controlled using a PWM signal output from the microprocessor (not shown) included in the controller 150 and an analog voltage output from the DAC is applied to the haptic feedback generator to change the intensity of the magnetic field.

The controller 150 executing the above functions may be configured of MCU, MPU or DSP and may be implemented using FPGA or ASIC. It is apparent to those skilled in the art that a memory (not shown) storing a program for driving the controller 150 is required.

The housing 160 according to the third embodiment of the present invention accommodates the magnetic field generator and is combined with the force transmitter 120. The housing 160 has the controller 150, which supplies electricity to the solenoid coils 111, at one side thereof. In addition, the housing 160 includes the magneto-rheological fluid 20 near the magnetic field formed in the direction perpendicular to the moving direction of the force transmitter 120.

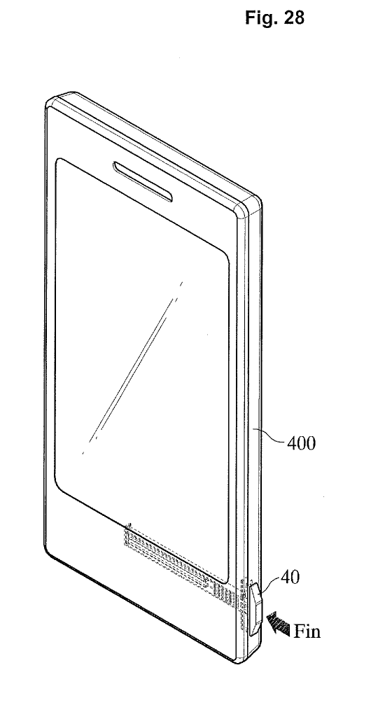

A portable device 400 including the haptic feedback generator 40 having the aforementioned configuration is shown in FIG. 28. The portable device 400 corresponds to a smart phone, a notebook computer, a tablet PC or a PDA. The portion of the portable device 400 to which haptic feedback generator 40 is provided can be freely changed and the portable device 400 can include multiple haptic feedback generators.

The microprocessor that transmits/receives signals to/from the haptic feedback generator 40 may have the same configuration as that of the controller 150 and acquires information generated from the portable device 400 to drive the haptic feedback generator 40. The microprocessor will be explained in the following fourth and fifth embodiments of the invention.

### Configuration of Fourth Embodiment

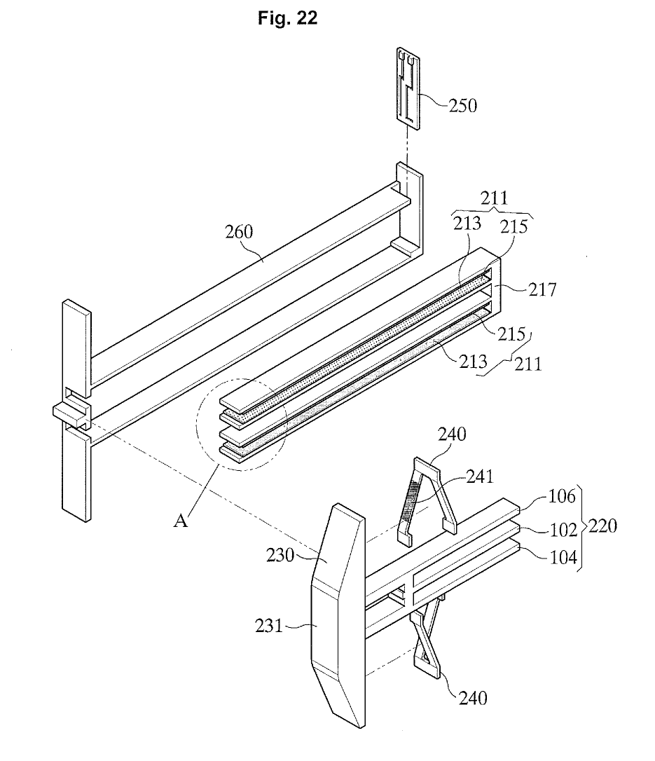

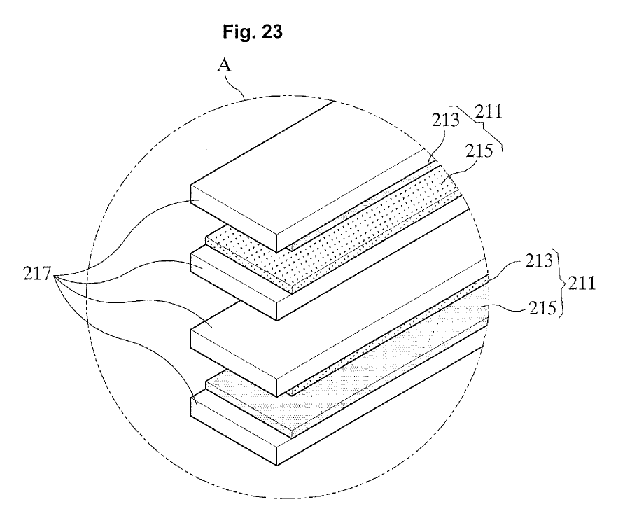

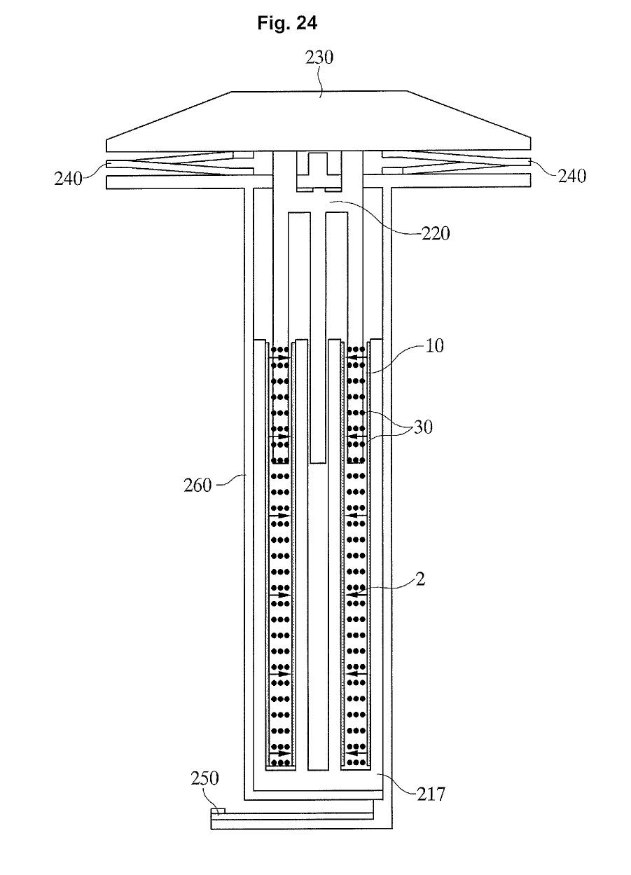

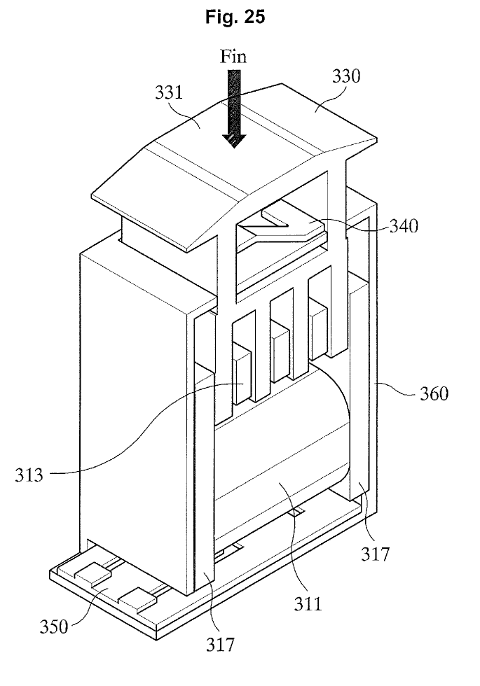

FIG. 21 is a perspective view of a haptic feedback generator according to the fourth embodiment of the present invention and FIG. 22 is an exploded perspective view of the haptic feedback generator according to the fourth embodiment of the present invention. FIG. 23 is an enlarged perspective view of an electrode plate of the haptic feedback generator according to the fourth embodiment of the present invention and FIG. 24 is a front view showing magnetic field flow in the haptic feedback generator according to the fourth embodiment of the present invention.

Referring to FIGS. 21, 22, 23 and 24, the haptic feedback generator according to the fourth embodiment of the present invention may include the electro-rheological fluid 30, an electric field generator generating an electric field, a force transmitter 220, and a push button 230 to which the external force Fᵢₙ is applied. In addition, the haptic feedback generator according to the fourth embodiment of the present invention may include an elastic spring 240, a displacement sensor 241, a housing 260, and a controller 250 transmitting/receiving a signal to/from an external device to generate the electric field.

The configuration of the haptic feedback generator according to the fourth embodiment of the present invention will now be explained in detail with reference to FIGS. 21, 22, 23 and 24. Only parts of the haptic feedback generator according to the fourth embodiment of the present invention, which are different from the haptic feedback generator according to the third embodiment of the present invention, are explained. Accordingly, explanations of the force transmitter 220, the push button 230, the sensor 231, the displacement sensor 241, the housing 260 and the controller 250 are omitted. However, the force transmitter 220 includes a first plunger 102 and second and third plungers 104 and 106 arranged at both sides of the first plunger 102, as shown in FIGS. 21 and 22, which is distinguished from the force transmitter 120 according to the third embodiment of the invention.

The electro-rheological fluid 30 according to the fourth embodiment of the present invention has viscosity varying with electric field. Specifically, the electro-rheological fluid 30 is a suspension composed of an insulating fluid and particles having high polarizability, which are dispersed in the insulating fluid. The electro-rheological fluid 30 has low viscosity when the electric field is not applied thereto and has high viscosity as if it is hardened when the electric field is applied thereto. That is, when the electro-rheological fluid 30 becomes high viscosity state, the user feels a haptic feedback.

Meanwhile, the viscosity of the electro-rheological fluid 30 abruptly increases under the influence of the applied electric field since the particles in the electro-rheological fluid 30 are arranged in a chain structure in the direction of the electric field. The viscosity of the electro-rheological fluid 30 increases in proportion to the intensity of the applied electric field. The electro-rheological fluid 30 is suitable for haptic applications due to its high tensile property, stiffness, stability and a wide temperature variation.

The electro-rheological fluid 30 is composed of polyaniline/titanium dioxide composite as conductive particles. That is, the electro-rheological fluid 30 is formed by dispersing an organic and inorganic composite compound of polyaniline that is a conductive polymer and titanium dioxide having a high dielectric constant in a nonconductive solvent. In this case, a high degree of polarization enhances electroheologial effect and the electro-rheological fluid 30 can operate without having an obstacle such as a temperature or external environment since inorganic and organic particles are used as conductive particles. More specifically, the electro-rheological fluid 30 is a polyaniline/TiO₂ organic and inorganic composite made by adding TiO₂ of 15 to 35 weight % of polyaniline.

The electric field generator according to the fourth embodiment of the present invention changes the property of the electro-rheological fluid 30 to generate an electric field for transmitting a haptic feedback to the user. The electric field generator includes electrode plates 211 and a yoke 217 for transmitting electricity.

Specifically, Each electrode plate 211 is composed of a positive electrode plate 213 and a negative electrode plate 215 to generate an electric field, as shown in FIG. 23. The two electrode plates 211 are arranged inside the yoke 217. The electrode plates 211 form an electric field which changes the property of the electro-rheological fluid 30 to form a chain.

The yoke 217 is shape-fitting-combined with the first, second and third force transmitting means 102, 104 and 106 of the force transmitter 220 to form the sliding tolerance 10 in which the electro-rheological fluid 30 is placed. The yoke 217 is connected with the controller 250 to be provided with electricity and is coated such that electricity does not flow through the yoke 210.

Referring to FIG. 24, when the external force Fᵢₙ is applied to the push button 230, the electro-rheological fluid 30 enters the sliding tolerance 10. Here, the electric field flows in a direction perpendicular to the moving direction of the force transmitter 220 to the electrode plates 211 such that the electro-rheological fluid 30 forms a chain to generate resistance. When the sensor 231 senses the external force Fᵢₙ applied to the push button 230, the sensor 231 outputs a signal corresponding to the sensing result to the controller 250, the controller 250 provides electricity and the electric field is formed from the positive electrode plate 213 to the negative electrode plate 215.

Since the viscosity of the electro-rheological fluid 30 varies according to the intensity of the electric field, an analog voltage of several kV is required to change the intensity of the electric field. To obtain the analog voltage, the DAC (not shown) is controlled using a PWM signal output from the microprocessor (not shown), as described above. Then, an analog voltage output from the DAC is applied to a DC-DC converter (not shown), amplified and applied to the haptic feedback generator to change the intensity of the electric field.

The controller 250 executing the above functions may be configured of MCU, MPU or DSP and may be implemented using FPGA or ASIC. It is apparent to those skilled in the art that a memory (not shown) storing a program for driving the controller 250 is required.

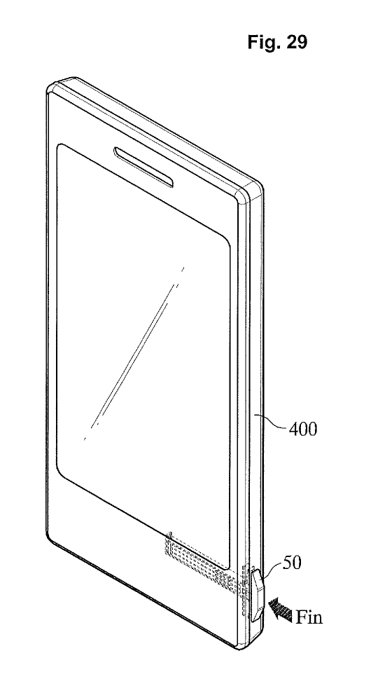

The portable device 400 including the haptic feedback generator 50 having the aforementioned configuration is shown in FIG. 29. The portion of the portable device 400 to which the haptic feedback generator 50 is provided may be freely changed and the portable device 400 can include multiple haptic feedback generators.

### Configuration of Fifth Embodiment

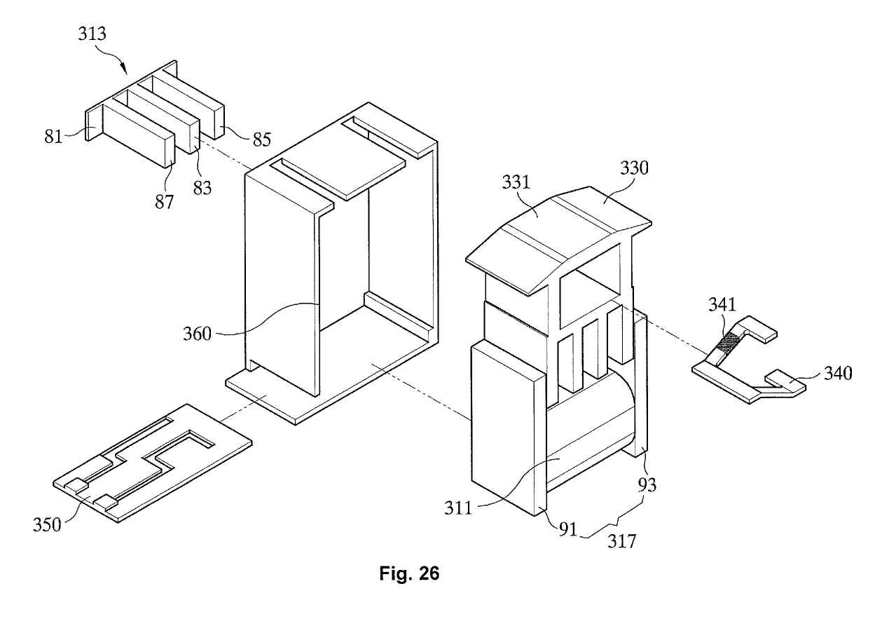

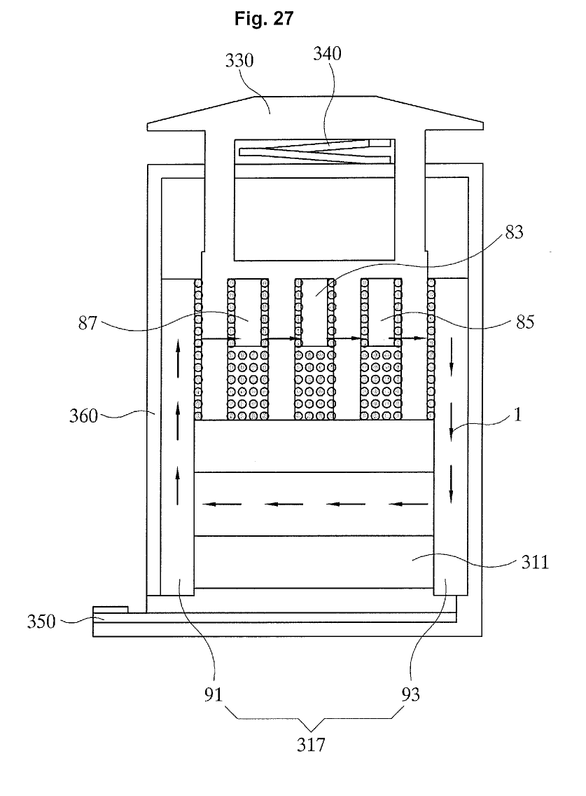

FIG. 25 is a perspective view of a haptic feedback generator according to the fifth embodiment of the present invention, FIG. 26 is an exploded perspective view of the haptic feedback generator according to the fifth embodiment of the present invention and FIG. 27 is a front view showing magnetic field flow in the haptic feedback generator according to the fifth embodiment of the present invention.

Referring to FIGS. 25, 26 and 27, the haptic feedback generator according to the fifth embodiment of the present invention may include the magnetic rheological fluid 20, a magnetic field generator generating a magnetic field, a force transmitter 320, and a push button 330 to which the external force Fᵢₙ is applied. In addition, the haptic feedback generator may include an elastic spring 340 responding to the user's external force, a displacement sensor 341, a housing 360, and a controller 350 transmitting/receiving a signal to/from an external device to generate the magnetic field.

The configuration of the haptic feedback generator will now be explained in detail with reference to FIGS. 25, 26 and 27. Only parts of the haptic feedback generator according to the fifth embodiment, which are different from the haptic feedback generator according to the third embodiment, are explained. Accordingly, explanations of the force transmitter 320, the push button 330, the sensor 331, the displacement sensor 341, and the controller 350, and the housing 360 are omitted.

The magnetic field generator according to the fifth embodiment of the present invention includes a solenoid coil 31, a solenoid inner core 313, a solenoid outer core 317, and an iron core 315. The magnetic field generator applies a magnetic field to the magneto-rheological fluid 20.

The function of the solenoid coil 311 is identical to that of the above-described solenoid coil 111. The solenoid coil 311 is combined with both sides of the solenoid outer core 317 in a direction perpendicular to the moving direction of the force transmitter 320. Here, the iron core 315 is located inside the solenoid coil 311. Although the haptic feedback generator includes a single solenoid coil, the haptic feedback generator may include multiple solenoid coils if required.

The solenoid inner core 313 is arranged in a direction corresponding to the solenoid coil 311 on a magnetic field flow route. The solenoid inner core 313 is combined with the housing 360 in a direction perpendicular to the moving direction of the force transmitter 320. The solenoid inner core 313 includes a combining part 81 combined with the housing 360, a first core 83, a second core 85 and a third core 87 extended from the combining part 81 in one direction to be shape-fitting-combined with the force transmitter 320.

The solenoid outer core 317 according to the fifth embodiment of the present invention is combined with both sides of the solenoid coil 311 and allows the magnetic field generated according to the solenoid coil 311 to flow around the solenoid outer core 317 to form a closed magnetic route. The solenoid outer core 317 is composed of plates 91 and 93 extended in one direction perpendicular to the direction of combining with the solenoid coil 311.

The elastic spring 340 according to the fifth embodiment of the present invention is located between the housing 360 and the push button 330 and bent in response to the user's external force Fᵢₙ. AS shown in FIGS. 25 and 26, the location of the elastic spring 340 is different from that of the elastic spring 140 according to the first embodiment of the invention.

Referring to FIG. 27, when the push button 330 acts according to the external force Fᵢₙ applied thereto, the magneto-rheological fluid 20 enters the sliding tolerance 10. Here, the magnetic field flows in a direction perpendicular to the moving direction of the force transmitter 320 such that the magneto-rheological fluid 20 forms a chain to generate resistance. The magnetic field generated from the solenoid coil 311 flows along the solenoid outer core 317 to the shape-fitting combined part to form a closed magnetic route.

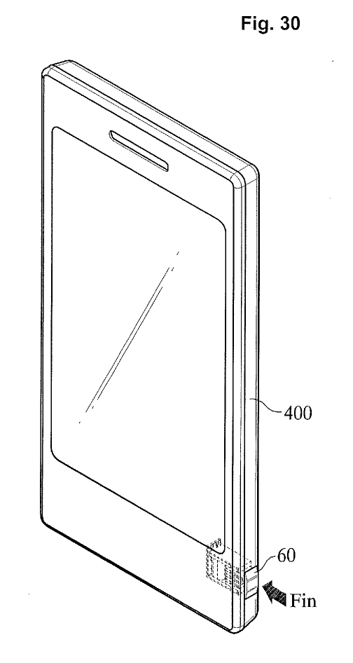

The portable device 400 including the haptic feedback generator 60 having the aforementioned configuration is shown in FIG. 30. The portion of the portable device 400 to which the haptic feedback generator 60 is provided can be freely changed and the portable device 400 can include multiple haptic feedback generators.

<Recording Medium>

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A haptic feedback generator comprising:
a controller outputting a control signal for providing a haptic feedback based on application information selected by a user; and
a haptic feedback generating unit generating the haptic feedback based on the control signal and providing the haptic feedback in response to an external force Fᵢₙ of the user.

2. The haptic feedback generator of claim 1, wherein the haptic feedback is resistance.

3. The haptic feedback generator of claim 2, wherein the resistance corresponds to a variation in shearing force or stiffness.

4. The haptic feedback generator of claim 2, wherein the haptic feedback corresponds to at least one of a resistance on/off method, a method of continuously generating the resistance and a method of generating the resistance in stages.

5. The haptic feedback generator of claim 2, wherein the haptic feedback generating unit 610 comprises;
a magnetic field generator generating a magnetic field based on the control signal and applying the magnetic field to a magneto-rheological fluid to generate the resistance; and
a plunger receiving the external force Fᵢₙ of the user and transmitting the resistance generated according to the intensity of the magnetic field to the user.

6. The haptic feedback generator of claim 2, wherein the haptic feedback generating unit comprises:
an electric field generator generating an electric field based on the control signal and applying the electric field to an electro-rheological fluid to generate the resistance; and
a plunger receiving the external force Fᵢₙ of the user and transmitting the resistance generated according to the intensity of the electric field to the user.

7. The haptic feedback generator of claim 4, wherein the resistance on/off method uses at least one of status information of a portable device, phone charge information of the portable device and information on operation importance of the portable device.

8. The haptic feedback generator of claim 4, wherein the method of continuously generating the resistance increases the resistance compared with the external force Fᵢₙ, makes the resistance constant and then decreases the resistance compared with the external force Fᵢₙ, or decreases the resistance compared with the external force Fᵢₙ.

9. The haptic feedback generator of claim 4, wherein the method of generating the resistance in stages increases the resistance in stages compared with the external force Fᵢₙ.

10. The haptic feedback generating apparatus of claim 1, wherein the haptic kinaethesia or sense of touch.

11. A portable device comprising:
a controller outputting a control signal for providing a haptic feedback based on application information selected by a user; and
a haptic feedback generator having a haptic feedback generating unit generating the haptic feedback based on the control signal and providing the haptic feedback in response to an external force Fᵢₙ of the user.

12. The portable device of claim 11, further comprising:
a memory storing an application; and
a microprocessor executing the application stored in the memory and outputting the application information to the controller according to the executed application.

13. The portable device of claim 12, further comprising a display displaying the state of execution of the application.

14. A haptic feedback providing method comprising:
a step S110 in which a controller receives application information executed in a portable device in order to generate a haptic feedback corresponding to the application information;
a step S120 in which the controller determined a haptic feedback method based on the application information; and
a step S140 in which the controller transmits the haptic feedback to a user based on the determined haptic feedback method.

15. The haptic feedback providing method of claim 14, further comprising a step S130 in which the controller generates the haptic feedback based on the haptic feedback method in order to transmit the haptic feedback to the user.

16. The haptic feedback providing method of claim 14, wherein the haptic feedback corresponds to resistance.

17. The haptic feedback providing method of claim 16, wherein the haptic feedback method corresponds to at least one of a resistance on/off method, a method of continuously generating the resistance and a method of generating the resistance in stages.

18. A computer readable recording medium storing a program for executing the haptic feedback providing method of claim 14.

19. A haptic feedback generator comprising:
a magnetic field generator generating a magnetic field 1 for changing the property of a magneto-rheological fluid to transmit a haptic feedback to a user and providing a closed magnetic route through which the magnetic field 1 can flow; and
a force transmitter combined with the magnetic field generator such that the magnetic field flows through the force transmitter,
wherein the magnetic field is formed at the combining portion of the magnetic field generator and the force transmitter 120 in a direction different from the moving direction of the force transmitter and changes the property of the magneto-rheological fluid located on the route of the magnetic field.

20. The haptic feedback generator of claim 19, further comprising:
a push button combined with the force transmitter and having an external force Fᵢₙ of a user applied thereto;
a sensor provided to one side of the push button and sensing the external force Fᵢₙ or touch of the user;
a housing having the magnetic field generator placed therein and combined with the force transmitter;
a controller provided to one side of the housing and transmitting/receiving a signal to/from an external device to output a control signal that varies the intensity of the magnetic field;
an elastic spring located between the housing and the push button and responding to the external force Fᵢₙ of the user; and
a displacement sensor sensing displacement of the force transmitter.

21. The haptic feedback generator of claim 20, wherein the displacement sensor is a piezo film sensor that is located at one side of the elastic spring and generates an electromotive force according to the response of the elastic spring.

22. The haptic feedback generator of claim 20, wherein the controller outputs the signal that varies the intensity of the magnetic field based on the signal of the sensor or the displacement sensor.

23. The haptic feedback generator of claim 19, wherein the magnetic field generator comprises:
a solenoid coil generating the magnetic field;
a solenoid core coming into contact with one side of the solenoid coil to allow the magnetic field to flow thereto, the magnetic field flowing in a direction different from the moving direction of the force transmitter at the combined portion of the solenoid core and the force transmitter; and
a solenoid housing having the solenoid coil and the solenoid core located therein and providing a route through which the magnetic field formed in the direction different from the moving direction of the force transmitter can flow along the solenoid housing.

24. The haptic feedback generator of claim 23, wherein the solenoid core, the solenoid housing and the force transmitter are shape-fitting-combined to form a sliding tolerance.

25. The haptic feedback generator of claim 23, wherein the magnetic field generator comprises a plurality of solenoid coils and magnetic fields generated according to the solenoid coils are combined at one side of the solenoid core and flow.

26. The haptic feedback generator of claim 23, wherein the solenoid coil has an iron core located inside thereof and winds a coil around the iron core.

27. A haptic feedback generator comprising:
an electric field generator generating an electric field for changing the property of an electro-rheological fluid to transmit a haptic feedback to a user; and
a force transmitter through which the electric field 2 generated by the electric field generator flows, the force transmitter cutting a chain of the electro-rheological fluid, which is formed according to the electric field, to generate the haptic feedback,
wherein the electric field is formed in a direction different from the moving direction of the force transmitter and changes the property of the electro-rheological fluid.

28. The haptic feedback generator of claim 27, further comprising:
a push button combined with the force transmitter and having an external force Fᵢₙ of a user applied thereto;
a sensor provided to one side of the push button and sensing the external force Fᵢₙ or touch of the user;
a housing having the electric field generator placed therein and combined with the force transmitter;
a controller provided to one side of the housing and transmitting/receiving a signal to/from an external device to output a control signal that varies the intensity of the electric field;
an elastic spring located between the housing and the push button and responding to the external force Fᵢₙ of the user; and
a displacement sensor sensing displacement of the force transmitter.

29. The haptic feedback generator of claim 28, wherein the displacement sensor is a piezo film sensor that is located at one side of the elastic spring and generates an electromotive force according to the response of the elastic spring.

30. The haptic feedback generator of claim 28, wherein the controller outputs the signal that varies the intensity of the electric field based on the signal of the sensor or the displacement sensor.

31. The haptic feedback generator of claim 27, wherein the electric field generator comprises:
an electrode plate having a positive electrode plate arranged at one side thereof and a negative electrode plate located at the other side thereof; and
a yoke having the electrode plate located therein and forming the electric field.

32. The haptic feedback generator of claim 31, the electric field generator comprises a plurality of electrode plates and the yoke is coated such that electricity does not flow through the yoke.

33. The haptic feedback generator of claim 31, wherein the yoke and the force transmitter are shape-fitting-combined with each other to form a sliding tolerance.

34. A haptic feedback generator comprising:
a magnetic field generator having a solenoid coil generating a magnetic field for changing the property of a magneto-rheological fluid to transmit a haptic feedback to a user, a solenoid outer core coming into contact with both sides of the solenoid coil and providing a closed magnetic route through which the magnetic field can flow along the solenoid outer core, and a solenoid inner core arranged in a direction corresponding to the solenoid coil on the route through which the magnetic field flows; and
a force transmitter combined with the solenoid inner core and the solenoid outer core, the magnetic field flowing through the force transmitter,
wherein the magnetic field is formed in a direction different from the moving direction of the force transmitter at the combining part of the solenoid inner core, the solenoid outer core and the force transmitter and changes the property of the magneto-rheological fluid located on the route of the magnetic field.

35. The haptic feedback generator of claim 34, further comprising:
a push button combined with the force transmitter and having an external force Fᵢₙ of a user applied thereto;
a sensor provided to one side of the push button and sensing the external force Fᵢₙ or touch of the user;
a housing having the magnetic field generator placed therein and combined with the force transmitter;
a controller provided to one side of the housing and transmitting/receiving a signal to/from an external device to output a control signal that varies the intensity of the magnetic field 1;
an elastic spring located between the housing and the push button and responding to the external force Fᵢₙ of the user; and
a displacement sensor sensing displacement of the force transmitter.

36. The haptic feedback generator of claim 35, wherein the displacement sensor is a piezo film sensor that is located at one side of the elastic spring and generates an electromotive force according to the response of the elastic spring.

37. The haptic feedback generator of claim 35, wherein the controller outputs the signal that varies the intensity of the magnetic field based on the signal of the sensor or the displacement sensor.

38. The haptic feedback generator of claim 34, wherein the solenoid inner core, the solenoid outer core and the force transmitter are shape-fitting-combined to form a sliding tolerance.

39. The haptic feedback generator of claim 34, wherein the solenoid coil has an iron core located inside thereof and winds a coil around the iron core.

40. A portable device comprising:
a haptic feedback generator according to claim 19; and
a microprocessor transmitting/receiving signals to/from the haptic feedback generator.

41. The portable device of claim 40, wherein a plurality of haptic feedback generators are included in the portable device to provide a haptic feedback to a user.

42. A portable device comprising:
a haptic feedback generator according to claim 27; and
a microprocessor transmitting/receiving signals to/from the haptic feedback generator.

43. The portable device of claim 42, wherein a plurality of haptic feedback generators are included in the portable device to provide a haptic feedback to a user.

44. A portable device comprising:
a haptic feedback generator according to claim 34; and
a microprocessor transmitting/receiving signals to/from the haptic feedback generator.

45. The portable device of claim 44, wherein a plurality of haptic feedback generators are included in the portable device to provide a haptic feedback to a user.
